(19) United States
(12) Patent Application Publication
(10) Pub. No.: US 2008/0182547 A1
(43) Pub. Date: Jul. 31, 2008

(54) User Worn Wireless Alarm

(76) Inventor: George Glover, Brooksville, FL (US)

Correspondence Address: SMITH HOPEN, PA, 180 PINE AVENUE NORTH, OLDSMAR, FL, 34677, US

(21) Appl. No.: 11/668,759

(22) Filed: Jan. 30, 2007

(51) Int. Cl. H04M 11/04

(52) U.S. Cl. 455/404.1

(57) ABSTRACT

A wireless transceiver worn about the hand, the transceiver adapted to initiate an outbound telephone call on a compatible mobile telephone responsive to actuating a button on the transceiver for a predetermined interval, the outbound telephone call is placed to a predetermined emergency telephone number, the transceiver transmitting audio to the mobile telephone.

### FIELD OF INVENTION

This invention relates to panic alarms, and specifically to wireless alarm device worn on a person that initiates an emergency telephone call responsive to activation.

### BACKGROUND OF THE INVENTION

According to the U.S. Department of Justice, Bureau of Justice Statistics, there were 2.6 victims of robbery per 1,000 individuals over the age of 12. Robberies increased from the previous year (2004) of 2.1 victims per 1,000 individuals. Robbery is defined by the U.S. Department of Justice as: “The taking or attempting to take anything of value from the care, custody or control from a person or persons by force or threat of force or violence and/or by putting the victim in fear.”

Convenience stores are usually open 24-hours, are largely a cash-based business, can be operated by one clerk, and are conveniently located for quick in and out shopping. The nature of this business makes it very convenient for customers. Unfortunately, this business style also makes it an attractive target for robbers and other criminals. A typical robbery will involve threatening the store clerk, often with a weapon and removing cash from the register. A clerk that attempts to call the police or signal for help may aggravate the criminal and subject the clerk to retribution.

A bank robbery occurs when the crime is robbery and the location is a financial institution. UCR-National Instant-Based Reporting System (NIBRS) standards state that the victims in a robbery can be either persons or entities, i.e., businesses, financial institutions, etc., or both. (See, U.S. Department of Justice. Federal Bureau of Investigation. (December 1999). NIBRS, Volume 1: Data Collection Guidelines, Washington D.C.: The Government Printing Office, p. 33.) In a bank robbery, the primary victim is the bank itself, but the teller being threatened or injured is also a victim. According to the United State Federal Bureau of Investigation, bank robberies accounted for 2.1% of all robberies in 2005. As with gas stations and convenience stores, furtive movements by an employee are discouraged as it often incites more violence by the criminal offender.

What is needed in the art is an alarm that the clerk can activate without making any furtive movements that would incident further violence.

Another need exists in the art is for an alarm that is inexpensive to manufacture.

Another need exists in the art is for an alarm that accommodates existing emergency response infrastructure.

Another need exists in the art is for an alarm that accommodates existing telecommunication infrastructure.

Another need exists in the art for an alarm that transmits audio of a criminal activity which may be of evidentiary value.

### SUMMARY OF INVENTION

The present invention is a wireless transceiver adapted to initiate an outbound telephone call on a compatible mobile telephone to a predetermined emergency telephone number, the transceiver transmitting audio to the mobile telephone. The outbound telephone call is initiated by actuating a button on the transceiver. The button must be engaged for a predetermine interval to initiate the outbound telephone call thereby reducing the incidence of false alarms. The transceiver is housed in an accessory worn about the body such as a finger ring. A test mode is provided for initiating an outbound telephone call to a predetermined non-emergency number.

The wireless specification is preferably IEEE 802.15 also known under the brand name BLUETOOTH. IEEE 802.15, a standardization of Bluetooth wireless specification defined by IEEE, is for wireless personal area networks (WPANs). IEEE 802.15 has characters such as short-range, low power, low cost, small networks and communication of devices within a Personal Operating Space.

The mobile phone or the transceiver itself is configured to mute audio from broadcasting from the transceiver and/or mobile phone. However, most mobile phones that have established a wireless connection to an earpiece automatically mute their integrated speaker. Thus, if mass-produced wireless earpieces are redeployed into the present invention, only the earpiece speaker, now housed within the ring housing, must be disabled for safety purposes.

### BRIEF DESCRIPTION OF THE DRAWINGS

For a fuller understanding of the invention, reference should be made to the following detailed description, taken in connection with the accompanying drawings, in which:

FIG. 1 is an elevated, isometric view of an embodiment of the invention worn on a finger.

FIG. 2 is an enlarged, elevated, isometric view of an embodiment of the invention showing a ring housing.

FIG. 3 is a diagrammatic view of an embodiment of the invention activated to transmit an emergency alarm.

FIG. 4 is a flowchart process of an embodiment of the invention.

### DETAILED DESCRIPTION OF THE PREFERRED EMBODIMENT

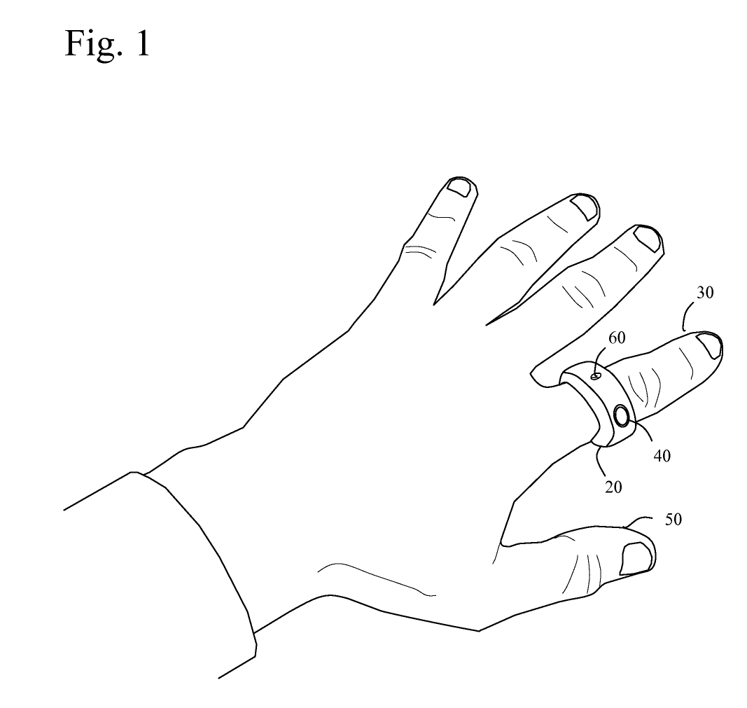

FIG. 1 shows an embodiment of the invention in ring housing 20 worn on index finger 30. Depressing button 40 with thumb 50 for a predetermined interval actuates transceiver in ring housing 20 to communicatively couple with a compatible mobile telephone and dial out a predetermined emergency number. Microphone 60 transmits audio to mobile telephone once connected with emergency number.

The advantages of this invention are numerous. First, by using a preexisting wireless communications protocol such as IEEE 802.15, manufacturing costs are greatly reduced and component inventories are widely available at relatively low cost. Millions of 802.15 earpieces are manufactured every year and virtually all the components may be integrated into the present invention with little or no modification to the circuitry. Mobile telephones that operate on cellular networks are ubiquitous and inexpensive. Furthermore, a criminal may seek to cut telephone service prior to the robbery to prevent the clerk from calling the phone via a land-line (twisted copper pair connection). However, by using a cell phone which may be hidden from view as it is wirelessly coupled to the invention, the criminal cannot reasonably circumvent this method of emergency communication.

Many mobile telephones are programmable via various languages such as J2ME, C++, Symbian, ASP.NET and the like. An embodiment of the invention includes installing a small program on the mobile telephone to detect when the transceiver makes an emergency connection with the mobile telephone, dials the predetermined emergency number and mutes audio incoming from the emergency responder. By muting the audio incoming from the emergency responder the transceiver essentially functions as a wireless earpiece redeployed into a ring worn by the user with one-way audio (output only). Without muting the incoming audio, the criminal might hear audio from the transceiver and thus endanger the wearer.

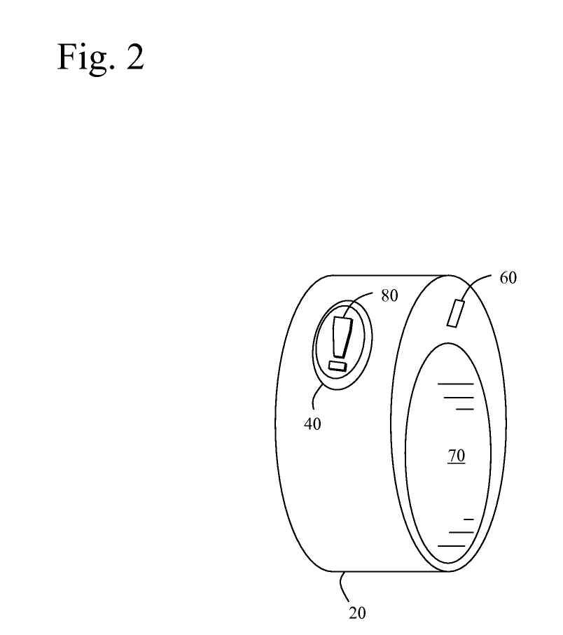

FIG. 2 shows an alternative embodiment of ring housing 20 wherein microphone 60 is relocated proximate to annular aperture 70 through which a finger is received. Button 40 displays indicia 80 to note its purpose. Indicia 80 may be illuminated by LED light to confirm the emergency alarm has been initiated.

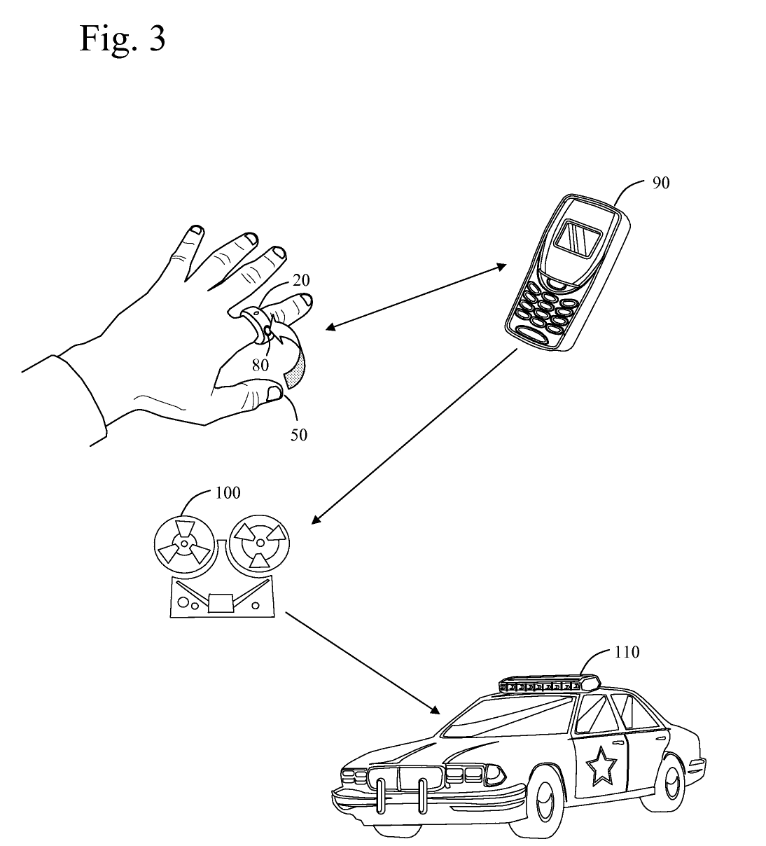

In FIG. 3, the operation of an embodiment of the invention is shown. Button 40 on ring housing 20 is actuated by thumb 50. Transceiver in ring housing 20 communicates via wireless connection to mobile phone 90. Mobile phone 90 places call to predetermined telephone number (such as 911) thereby establishing a telephone connection with emergency dispatch 100. Audio received through microphone 60 is relayed to emergency dispatch 100 which typically records all incoming calls. Thus, it is possible to record the communications between criminal and victim(s). Emergency display 100 then sends response instructions to emergency responder 1110.

In the United States, the Federal Communications Commission (FCC) requires networks to route every mobile-phone 911 call to an emergency service call center, including phones that have never had service, or whose service has lapsed. As a result, there are programs that provide donated used mobile phones to victims of domestic violence and others especially likely to need emergency services. Thus, mobile phones suitable for the present invention require little to no monthly fees. Enhanced 911 service allows a wireless or mobile telephone to be located geographically using some form of radiolocation from the cellular network, or by using a Global Positioning System built into the phone itself. Radiolocation in cellular telephony uses base stations. Most often, this is done through triangulation between radio towers.

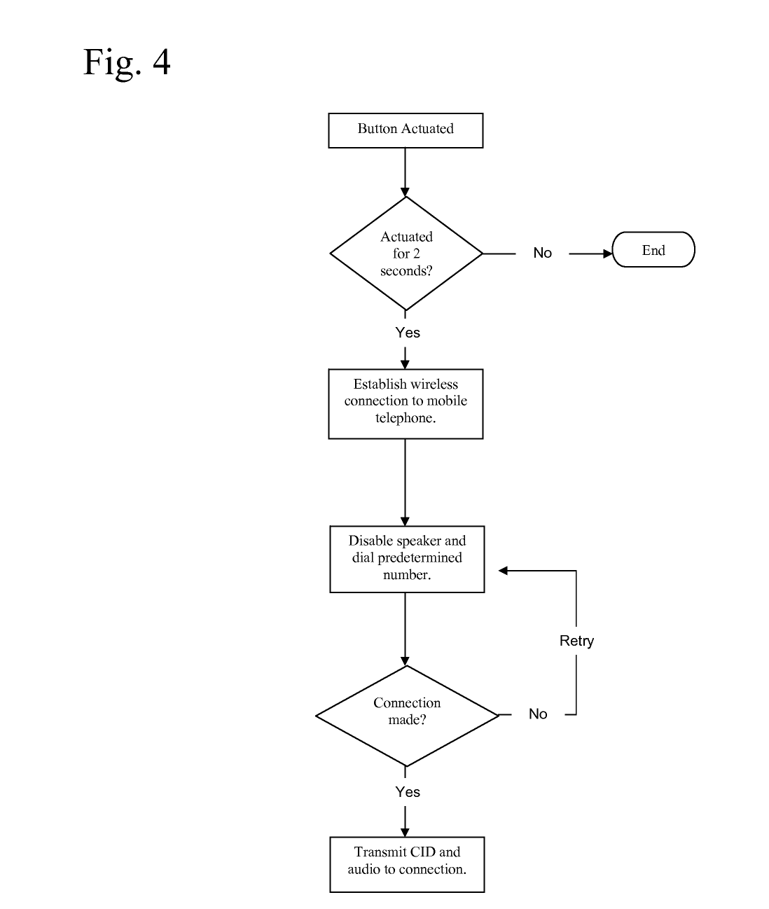

FIG. 4 shows the method by which an embodiment of the invention is enabled. Button 40 is actuated for a predetermined interval (2 second in this example) causing transceiver to establish a wireless connection to mobile telephone 90. The cell phone speaker and the transceiver's integrated speaker if present are disabled to prevent the criminal from knowing a call has been placed. The predetermined emergency number is dialed and a connection is verified. Caller identification information (CID) and/or radiolocation data identifies the location of the calling mobile phone to the emergency responder.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. Wireless transceiver adapted to initiate an outbound telephone call on a compatible mobile telephone to a predetermined emergency telephone number, the transceiver transmitting audio to the mobile telephone.

2. The transceiver of claim 1 wherein the outbound telephone call is initiated by actuating a button on the transceiver.

3. The transceiver of claim 2 wherein the button must be engaged for a predetermine interval to initiate the outbound telephone call thereby reducing the incidence of false alarms.

4. The transceiver of claim 1 wherein the transceiver is housed in an accessory worn about the body.

5. The transceiver of claim 4 wherein the accessory is a finger ring.

6. The transceiver of claim 1 further comprising a test mode for initiating an outbound telephone call to a predetermined non-emergency number.

7. Wireless ring-shaped transceiver adapted to initiate an outbound telephone call on a compatible mobile telephone responsive to actuating a button on the transceiver for a predetermined interval, the outbound telephone call is placed to a predetermined emergency telephone number, the transceiver transmitting audio to the mobile telephone.

8. An IEEE 802.15 specification ring-shaped transceiver adapted to initiate an outbound telephone call on an IEEE 802.15-compatible mobile telephone responsive to actuating a button on the transceiver for a predetermined interval, the outbound telephone call is placed to a predetermined emergency telephone number, the transceiver transmitting audio to the mobile telephone.

9. An IEEE 802.15 specification ring-shaped transceiver adapted to initiate an outbound telephone call on an IEEE 802.15-compatible mobile telephone responsive to actuating a button on the transceiver for a predetermined interval, the outbound telephone call is placed to a predetermined emergency telephone number, the transceiver transmitting audio to the mobile telephone and muting audio from the mobile telephone.

10. The transceiver of claim 9 wherein the mobile phone is configured to mute audio from broadcasting from the transceiver.

11. The transceiver of claim 9 wherein the transceiver is configured to mute audio from broadcasting from the transceiver.
